(19) United States
(12) Patent Application Publication
(10) Pub. No.: US 2007/0193114 A1
(43) Pub. Date: Aug. 23, 2007

(54) Watering device and method of using the same

(76) Inventor: Edmund T. Kochling, Charlton, MA (US)

Correspondence Address: KRIEGSMAN & KRIEGSMAN, 30 TURNPIKE ROAD, SUITE 9, SOUTHBOROUGH, MA, 01772, US

(21) Appl. No.: 11/635,803

(22) Filed: Dec. 7, 2006

Related U.S. Application Data
(60) Provisional application No. 60/748,021, filed on Dec. 7, 2005.

(51) Int. Cl. A01G 29/00

(52) U.S. Cl. 47/48.5

(57) ABSTRACT

A watering device well-suited for use in watering soil that surrounds a plant includes an inlet adapted to receive a supply of water, an elongated length of rigid tubing shaped to define an outlet, the outlet being in fluid communication with the inlet, and a shut-off valve for regulating the flow of water from the inlet to the outlet. In use, the tubing is inserted deep into the layer of soil. The shut-off valve is then opened so that water is dispensed from the outlet, water being dispensed until the soil is thoroughly saturated with water. At that time, water present in the soil naturally drains downward which in turn results in substantial compaction of the soil. This process of compaction serves to eliminate the presence of any harmful air pockets in the soil.

### CROSS-REFERENCE TO RELATED APPLICATIONS

The present application claims the benefit under 35 U.S.C. 119(e) of U.S. Provisional Patent Application Ser. No. 60/748,021, filed Dec. 7, 2005, the disclosure of which is incorporated herein by reference.

### BACKGROUND OF THE INVENTION

The present invention relates generally to watering devices and more particularly to a novel watering device and a method of using the same.

Plants (e.g., trees, shrubs, flowers, etc.) are typically planted or transplanted in soil using a well-known four-step planting process. In the first step, a hole is dug in the soil where the plant is to be placed, the size of the hole being preferably larger than the base of the plant (the base typically including the roots as well as any soil adhered to the roots). In the second step, the base of the plant is positioned within the hole. In the third step, soil is deposited around the base of plant so as to completely fill in the previously created hole, the added soil being packed as deemed necessary to adequately support the plant in the hole. In the final step of the process, the plant is watered. Traditionally, such watering is effected using a watering can or a conventional garden hose and involves spraying the leaves of the plant and spraying water down onto the soil surrounding the plant.

### SUMMARY OF THE INVENTION

The present inventor has discovered that the above-described planting process suffers from certain shortcomings. One such shortcoming is that the soil that is added to the hole around the base of the plant typically contains a number of air pockets or voids. As can be appreciated, the presence of these air pockets or voids in places that immediately surround the roots of the plant may effectively inhibit the delivery of water and other essential nutrients in the soil to the plant. As a consequence, the presence of these air pockets in soil creates a harmful condition that can compromise the overall health of the plant.

It is an object of the present invention to provide a novel method of planting or transplanting plants that overcomes the aforementioned shortcoming.

According to one embodiment, the method comprises the steps of (a) creating a hole adapted to receive the base of a plant; (b) placing the base of the plant in the hole; (c) adding soil around the base of the plant; (d) inserting the output end of a watering device into the added soil; (e) dispensing water through the output end of the watering device into the added soil until the added soil is substantially compacted; (f) adding an additional volume of soil onto the compacted added soil; (g) inserting the output end of the watering device into the newly added soil; (h) dispensing water through the output end of the watering device into the newly added soil until the newly added soil is substantially compacted; and (i) if necessary, repeating steps (f) through (h) until the hole is substantially filled with compacted soil.

The present invention is also directed at a watering device that is particularly well-suited for use in the novel method described above.

According to one embodiment, the watering device of the present invention comprises (a) a waterflow regulation mechanism, and (b) a spout coupled to the waterflow regulation mechanism, the spout comprising an elongated length of rigid tubing.

The present invention is also directed at a method of adding water to a volume of soil.

According to one embodiment, the method of adding water to a volume of soil comprises the steps of (a) providing a watering device, the watering device comprising an elongated length of rigid tubing, the elongated length of rigid tubing having an output end, (b) inserting the output end of the elongated length of rigid tubing into the volume of soil such that the output end is disposed beneath the top of the volume of soil, (c) delivering a supply of water to the volume of soil through the output end of the elongated length of rigid tubing, and (d) removing the elongated length of rigid tubing from the volume of soil.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a top perspective view of a watering device constructed according to the teachings of the present invention;

FIG. 2 is an exploded, top perspective view of the watering device shown in FIG. 1; and

FIGS. 3(a)-(f) are a series of partial section views which are useful in understanding a novel method of planting or transplanting a plant, the method being set forth according to the teachings of the present invention, selected stages of the process being shown using the watering device of FIG. 1.

### DETAILED DESCRIPTION OF THE PREFERRED EMBODIMENT

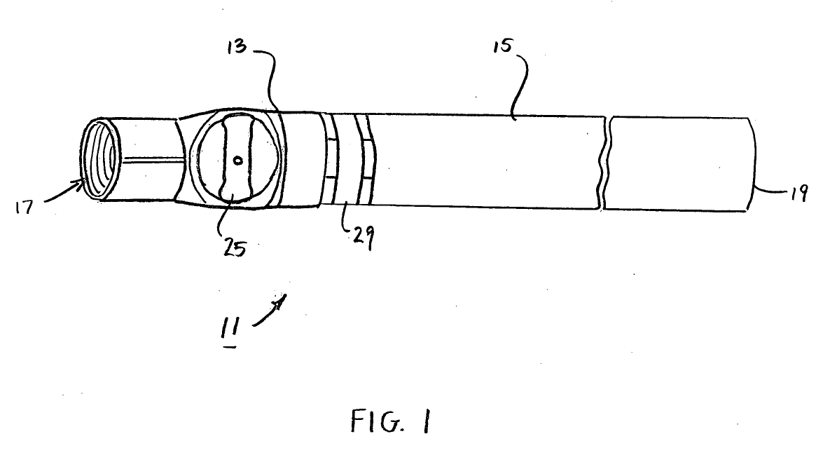

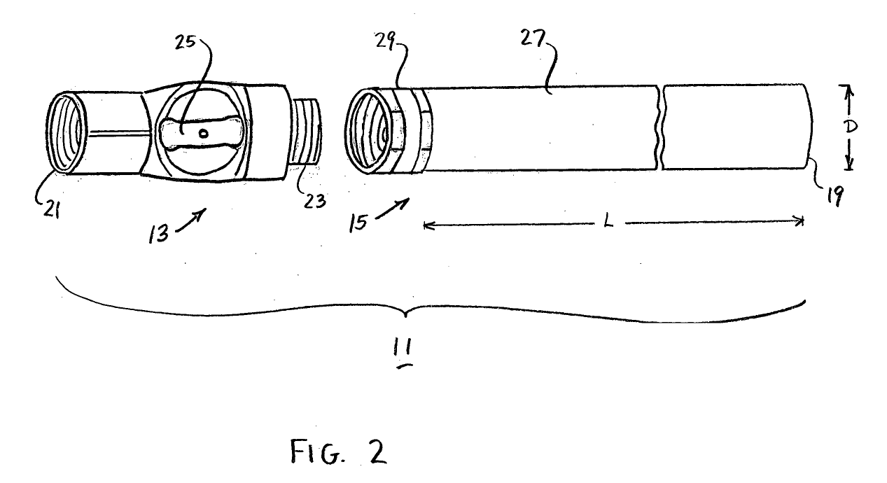

Referring now to FIGS. 1 and 2, there is shown a watering device constructed according to the teachings of the present invention, the watering device being identified generally by reference numeral 11. As will be described further in detail below, watering device 11 is designed principally for use in conjunction with a novel method of treating the soil that supports a plant. However, it is to be understood that additional uses for watering device 11 (including non-gardening uses, such as for washing a car or the like) could be derived without departing from the spirit of the present invention.

### Construction of Watering Device 11

Watering device 11 comprises a water flow regulation mechanism 13 and a spout 15, mechanism 13 and spout 15 being mechanically coupled together so as to effectively render device 11 a unitary item. As seen most clearly in FIG. 1, device 11 has an elongated, generally tubular design and is shaped to include an inlet 17 at one of its ends and an outlet 19 at the other of its ends, inlet 17 and outlet 19 being in fluid communication with one another. As will be described further below, inlet 17 is designed to receive a supply of water from a water source, the supply of water in turn being selectively expelled out from device 11 through outlet 19.

As seen most clearly in FIG. 2, water flow regulation mechanism 13 is represented herein as being in the form of a generally tubular shut-off valve which includes a threaded female connector 21 at one end, a threaded male connector 23 at its opposite end and a manually controllable ball-valve 25 located between connectors 21 and 23. Preferably, threaded female connector 21 is sized and shaped to matingly receive the threaded male connector of a conventional garden hose.

It is to be understood that valve 25 is capable of being rotated 90 degrees between a closed position (as shown in FIG. 1) and an open position (as shown in FIG. 2). With valve 25 disposed in its closed position, water supplied to device 11 through inlet 17 is effectively blocked and thereby unable to exit device 11 through outlet 19. To the contrary, with valve 26 disposed in its open position, water supplied to device 11 through inlet 17 passes through the length of device 11 and is expelled out through outlet 19.

It is to be understood that water flow regulation mechanism 13 is not limited to the particular design as shown herein. Rather, it is to be understood that mechanism 13 could be replaced with any well-known means for regulating the flow of water (e.g., a global valve or gate valve) without departing from the spirit of the present invention.

Spout 15 comprises an elongated length of tubing 27 that is shaped to define an outlet 19 at one of its ends. Preferably, tubing 27 is constructed out of a highly rigid material, such as, but not limited to, polyvinyl chloride (PVC). As can be appreciated, the rigid nature of tubing 27 renders device 11 highly durable and easy to use. In particular, the rigid nature of tubing 27 permits tubing 27 to be inserted through soil more easily than it would be to insert a conventional garden hose through soil.

Tubing 27 preferably has a length L of approximately 12 inches. As will be described further below, the substantial length of tubing 27 allows for water to be delivered to a layer of soil at a location substantially beneath its top surface. Consequently, as the water drains, the layer of soil is rendered more compact and therefore less susceptible to presence of harmful air pockets, as will be described further below.

Length of tubing 27 also preferably has a diameter D of 0.75 inches. It should be noted that due to the relatively large diameter of outlet 19, water expelled from device 11 exits as a substantially large yet soft stream, thereby providing its user with maximum output flow (i.e., greater efficiency) and greater control (i.e., less mess).

Finally, it should be noted that, in the present embodiment, outlet 19 of tubing 27 is blunt, as opposed to sharpened. It is believed by the present inventor that such a blunt end is advantageous as it will reduce the likelihood that roots may be severed as tubing 27 is inserted into or removed from the soil surrounding a plant. Notwithstanding the above, outlet 19 of tubing 27 need not be blunt and may be sharpened or have some other profile.

A threaded female connector 29 is coupled to tubing 27 on the opposite end from outlet 19. As such, it is to be understood that mechanism 13 and spout 15 can be secured together through the threaded engagement between male connector 23 on mechanism 13 and the female connector 29 on spout 15.

It is to be understood that watering device 11 is not limited to the two-piece construction as described herein. Rather, it is to be understood that water flow regulation mechanism 13 and spout 15 could be integrally formed together during the construction of watering device 11 without departing from the spirit of the present invention.

Novel Method of Treating the Soil that Supports a Plant using Device 11

As noted briefly above, watering device 11 is designed principally for use in conjunction with a novel method of treating the soil that supports a plant, the method being implemented according to the teachings of the present invention.

As defined herein, use of the term “plant” relates to any living stage or form of any member of the plant kingdom including, but not limited to, trees, shrubs, flowers, herbs and ferns.

As defined herein, use of the term “soil” relates to any compound or mixture that is commonly utilized to support plant growth.

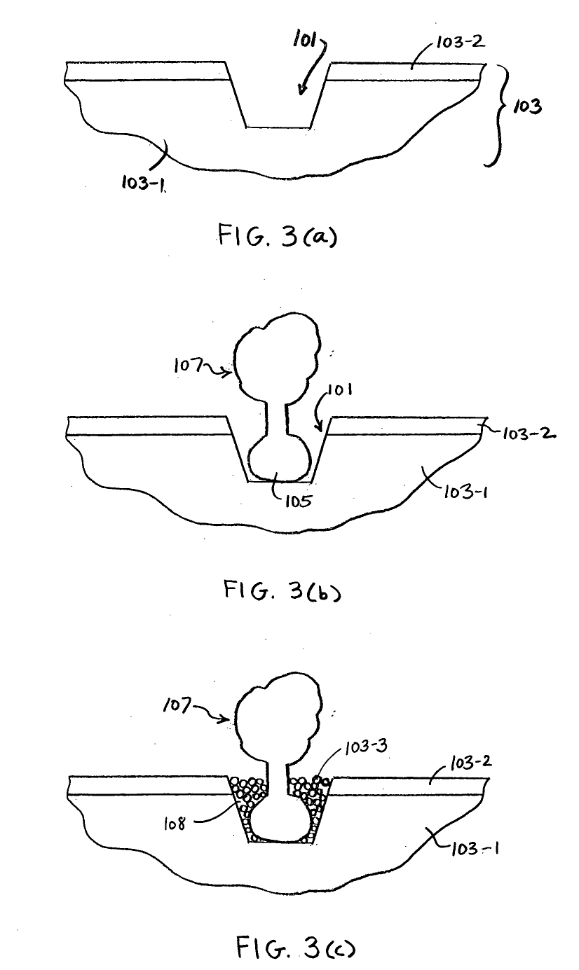

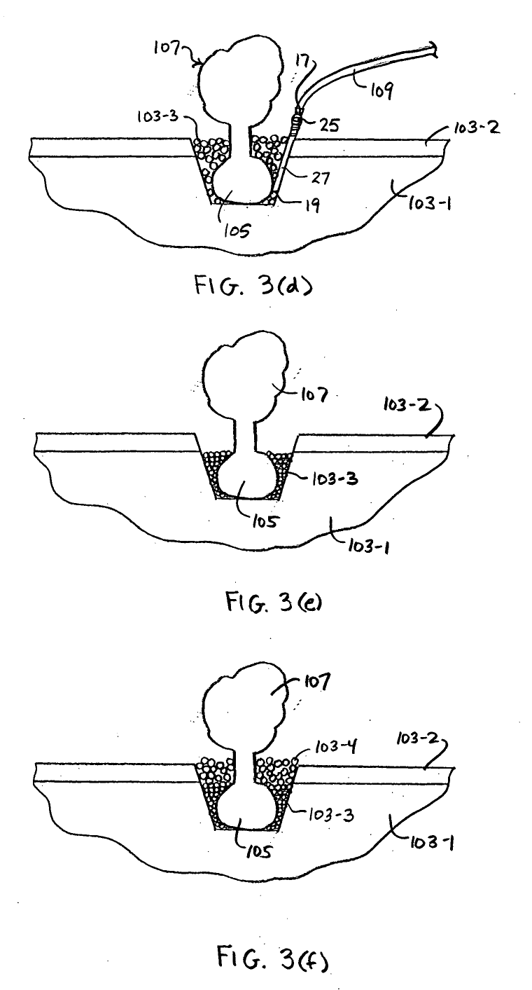

Referring now to FIGS. 3(a)-(g) there is shown a series of partial section views which may be useful in understanding the planting process of the present invention. For purposes of simplicity only, the planting process is being shown in conjunction with the transplantation of a plant into the earth. However, it is to be understood that the planting process of the present invention could be utilized in a wide variety of different applications (e.g., the transplantation of a plant from the earth to a pot) without departing from the spirit of the present invention.

In the first step of the novel process, a hole 101 is formed in a supply of soil 103, the supply of soil 103 preferably comprising a layer of preexisting subsoil 103-1 and a layer of top soil 103-2, as shown in FIG. 3(a). Preferably, the hole 101 formed in soil 103 is sufficiently deep and wide to receive the base of the plant to be implanted.

Referring now to FIG. 3(b), the base 105 of a plant 107 to be implanted is positioned within hole 101 in soil 103. As defined herein, base 105 represents the portion of a plant 107 that is typically buried within soil when planted conventionally (e.g., the roots of plant 107). With plant 107 positioned as such, a first layer of new soil 103-3 is deposited around base 105 so as to completely fill in hole 101, as seen most clearly in FIG. 3(c). Preferably, first layer of new soil 103-3 is sufficiently packed so that plant 107 is adequately supported.

However, regardless of the extent to which it is packed, new soil 103-3 is not particularly dense (e.g., in comparison with subsoil 103-1). As a result, a number of sizable air gaps 108 are naturally present within soil 103-3, as seen most clearly in FIG. 3(c). It is to be understood that presence of air gaps 108 limits the delivery of essential nutrients to base 105; as a consequence, air gaps 108 are detrimental to the overall health of plant 107.

As a result, with valve 25 of device 11 switched to its closed position, length of tubing 27 is inserted down into first layer of new soil 103-3 until outlet 19 is disposed in close proximity to the bottom of the previously defined hole 101 (i.e., such that outlet 19 is positioned directly beside or beneath base 105 of plant 107), as seen most clearly in FIG. 3(d). After inlet 17 of device 11 is properly coupled to a supply of water (e.g., garden hose 109), valve 25 is opened which in turn saturates the bottom of the first layer of new soil 103-3. Once new layer of soil 103-3 is adequately saturated throughout its depth, valve 25 is closed and tubing 27 is withdrawn from soil 103-3. Preferably, rigid tubing 27 is reinserted into first layer of new soil 103-3 at different locations about the periphery of base 105 (with valve 25 selectively opened) until the entire first layer of new soil 103-3 is completely saturated (preferably such that soil 103-3 has a soup-like consistency).

Once the new soil 103-3 is completely saturated in the manner described above (i.e., with the water introduced from its bottom), tubing 27 is withdrawn. At this time, the water present in first layer of new soil 103-3 drains down into preexisting subsoil 103-1. As the water drains, first layer of new soil 103-3 will become significantly compacted, thereby lowering the level of the top surface of first layer of new soil 103-3, as shown in FIG. 3(e). As can be appreciated, the substantial compaction of new soil 103-3 serves to eliminate the presence of air voids 108 therein, which is highly desirable.

Because the compaction of new soil 103-3 serves to lower its top surface, an additional layer of new soil 103-4 may be deposited around base 103 of plant 105 on top of first layer of new soil 103-3, as shown in FIG. 3(f). Preferably, the amount of new soil 103-4 added is such that the top layer of new soil 103-4 roughly aligns with the top layer of top soil 103-2.

Preferably, the soil saturation process described in detail above with respect to first layer of new soil 103-3 (and depicted generally in FIGS. 3(d)-(e)) can be repeated with respect to additional layer of new soil 103-4. In this manner, the additional layer of new soil 103-4 can be compacted in a similar manner as first layer of new soil 103-3. Additional layers of new soil can be deposited onto layer of new soil 103-4 and subsequently saturated in a similar manner as described above until the entire hole 101 is filled around base 103 of plant 105 with highly compacted soil 103 (i.e., soil that does not have air pockets).

It should be noted that the above-described method of treating the soil that supports a plant introduces a notable advantage. Specifically, the saturation process described above ensures that the one or more layers of new soil that are used to support the base of the plant are highly compacted. As a consequence of its high level of compaction, the presence of harmful air voids in the soil is minimized, thereby ensuring that nutrients in the soil are delivered to the roots of the plant, which is a principal object of the present invention.

It should also be noted that, in addition to being used in the manner described above to plant or to transplant plants, watering device 11 may also be used for watering already-planted plants. Such watering may involve inserting outlet 19 into soil and dispensing water below the top surface of the soil or may involve watering the plant and surrounding soil from above the top surface of the soil.

It should also be noted that, by attaching watering device 11 to the outlet end of a conventional garden hose that is, in turn, connected to a spigot, one can control the flow of water through outlet 19 of watering device 11 without having to turn water on and off at the spigot. Instead, one simply places valve 25 in the “off” position, tuns the spigot on, and then places valve 25 in the “on” position when one is ready to actually begin watering. When one is done watering, one then places valve 25 in the “off” position and then turns the spigot off. As can be appreciated, this feature may be particularly advantageous when watering plants that are located remotely relative to a spigot.

The embodiment shown of the present invention is intended to be merely exemplary and those skilled in the art shall be able to make numerous variations and modifications to them without departing from the spirit of the present invention. All such variations and modifications are intended to be within the scope of the present invention as defined in the appended claims.

What is claimed is:

1. A method of treating a first layer of soil that supports a plant, the first layer of soil having a top surface and at least one air pocket present therein, said method comprising the steps of:
(a) providing a watering device which is shaped to define an inlet and an outlet in fluid communication with one another, the watering device comprising an elongated length of rigid tubing, the outlet being defined at one end of the elongated length of rigid tubing,
(b) inserting at least a portion of the elongated length of rigid tubing into the first layer of soil such that the outlet is disposed substantially beneath the top surface of the first layer of soil,
(c) delivering a supply of water into the inlet of the watering device, the supply of water exiting the watering device through the outlet, and
(d) withdrawing the elongated length of rigid tubing from the first layer of soil.

2. The method as claimed in claim 1 wherein the delivery step results in the first layer of soil being saturated with water.

3. The method as claimed in claim 2 further comprising the step of, after the delivery step, draining the water present in the first layer of soil.

4. The method as claimed in claim 3 wherein the draining step results in the compaction of the first layer of soil.

5. The method as claimed in claim 4 wherein the compaction of the first layer of soil eliminates the presence of the at least one air pocket present therein.

6. The method as claimed in claim 5 wherein the compaction of the first layer of soil lowers the level of its top surface.

7. The method as claimed in claim 6 further comprising the step of, after the draining step, depositing a second layer of soil on top of the first layer of soil.

8. The method as claimed in claim 7 further comprising the step of, after the depositing step, saturating the second layer of soil with water.

9. The method as claimed in claim 8 wherein the watering device comprises a valve located between the inlet and outlet, the valve regulating the passage of water from the inlet to the outlet.

10. A watering device comprising:
(a) a water flow regulation mechanism, and
(b) a spout coupled to the water flow regulation mechanism, the spout comprising an elongated length of rigid tubing.

11. The watering device as claimed in claim 10 wherein said water flow regulation mechanism is adapted for connection to a garden hose.

12. The watering device as claimed in claim 10 wherein the rigid tubing is approximately 12 inches in length.

13. The watering device as claimed in claim 12 wherein the rigid tubing has a diameter of approximately 0.75 inches.

14. The watering device as claimed in claim 13 wherein the rigid tubing is constructed of plastic.

15. The watering device as claimed in claim 14 wherein the water flow regulation mechanism includes a shut-off valve.

16. The watering device as claimed in claim 15 wherein the water flow regulation mechanism and the spout are threadingly coupled to one another.

17. A method of planting comprising the steps of:
(a) creating a hole adapted to receive the base of a plant;
(b) placing the base of the plant in the hole;
(c) adding soil around the base of the plant;
(d) inserting the output end of a watering device into the added soil;
(e) dispensing water through the output end of the watering device into the added soil until the added soil is substantially compacted;
(f) adding an additional volume of soil onto the compacted added soil;
(g) inserting the output end of the watering device into the newly added soil;
(h) dispensing water through the output end of the watering device into the newly added soil until the newly added soil is substantially compacted; and
(i) if necessary, repeating steps (f) through (h) until the hole is substantially filled with compacted soil.
